(19) United States
(12) Patent Application Publication
(10) Pub. No.: US 2012/0064392 A1
(43) Pub. Date: Mar. 15, 2012

(54) ELECTRODE MATERIAL FOR LITHIUM ION BATTERIES AND LITHIUM ION BATTERIES THEREOF

(76) Inventors: Lihui Qu, Shenzhen (CN); Wenfeng Jiang, Shenzhen (CN); Yanchu Liu, Shenzhen (CN); Yu Xia, Shenzhen (CN); Fuzhong Pan, Shenzhen (CN)

(21) Appl. No.: 13/300,982

(22) Filed: Nov. 21, 2011

Related U.S. Application Data
(63) Continuation of application No. PCT/CN2010/072718, filed on May 13, 2010.

(30) Foreign Application Priority Data
May 27, 2009 (CN) 200910107761.6

(51) Int. Cl. H01M 2/02; H01B 1/02

(52) U.S. Cl. 429/163; 252/512; 252/513

(57) ABSTRACT

An electrode material for a lithium ion battery comprises an electrode active material, an adhesive and a hydrogen storage alloy. The hydrogen storage alloy includes at least one selected from AB₅ type Nickel based hydrogen storage alloys, AB₂ type Laves phase hydrogen storage alloys, A₂B type Magnesium based hydrogen storage alloys, and V-based solid solution type hydrogen storage alloys. A lithium ion battery containing the electrode material is also provided herein.

### CROSS-REFERENCE TO RELATED APPLICATION

This application is a continuation of International Application No. PCT/CN2010/072718, filed May 13, 2010, designating the United States of America, which claims priority to Chinese Patent Application No. 200910107761.6, filed May 27, 2009, the entirety of both of which are hereby incorporated by reference.

### BACKGROUND

Lithium ion batteries have been widely used because of their high voltage, long cycle life, no memory effect, less self-discharge, and environmental friendliness. The electrolyte is an important part for lithium ion batteries. As the existing electrolyte can react with water easily, if the manufacturing process and environment are not strictly controlled, the battery may easily expand or even explode during the formation or cycling process.

To solve this problem, the existing technology strictly controls the water content in the manufacturing process and environment, which is complex and requires special equipment with high cost. Another method is to eliminate the air when sealing the battery at the end of formation. This method can relieve the problem of air-expansion during the formation but not the cycling process. Especially for batteries using lithium titanate as the electrode active material, air-expansion during the conventional formation process is too serious to form high quality produces.

It would be desirable to further improve the electrode material and lithium ion batteries thereof to avoid battery air-expansion during formation and cycling.

### SUMMARY

The present disclosure is aimed to solve at least one of the problems existing in the art. An electrode material and a lithium ion battery thereof are disclosed herein.

An electrode material for a lithium ion battery disclosed herein comprises an electrode active material, an adhesive and a hydrogen storage alloy. In some embodiments, the hydrogen storage alloy is at least one selected from AB₅ type Nickel based hydrogen storage alloys, AB₂ type Laves phase hydrogen storage alloys, A₂B type Magnesium based hydrogen storage alloys, and V-based solid solution type hydrogen storage alloys.

Another aspect of the present disclosure disclosed a lithium ion battery comprising: a battery shell, an electrolyte and a battery core within the battery shell, wherein the battery core comprises a cathode, an anode and a separator therebetween, the cathode and/or the anode comprising a hydrogen storage alloy.

Other variations, embodiments and features of the present disclosure will become evident from the following detailed description.

### DETAILED DESCRIPTION OF THE EMBODIMENTS

It will be appreciated by those of ordinary skills in the art that the disclosure can be embodied in other specific forms without departing from the spirit or essential character thereof. The presently disclosed embodiments are therefore considered in all respects to be illustrative and not restrictive.

An electrode material for a lithium ion battery is disclosed herein comprising an electrode active material, an adhesive and a hydrogen storage alloy.

In some embodiments, the hydrogen storage alloy is at least one selected from AB₅ type Nickel based hydrogen storage alloys, AB₂ type Laves phase hydrogen storage alloys, A₂B type Magnesium based hydrogen storage alloys, and V-based solid solution type hydrogen storage alloys. In some embodiments, the AB₅ type Nickel based hydrogen storage alloys may include NaNi₅; and the A₂B type Magnesium based hydrogen storage alloys may include Mg₂M, wherein M is an element selected from V, Cr, Mn, Fe, Co and Mo; the V-based solid solution type hydrogen storage alloys may include V—Ti alloys and V—Ti—Cr alloys. In some embodiments, the hydrogen storage alloy of the present disclosure includes the AB₂ type Laves phase hydrogen storage alloys. In some embodiments, the AB₂ type Laves phase hydrogen storage alloys include at least one selected from ZrV₂, ZrCr₂ and ZrMn₂.

In some embodiments, the hydrogen storage alloy ranges from about 0.1% to about 20% of the electrode active material by weight. In some embodiments, the hydrogen storage alloy ranges from about 0.5% to about 5% of the electrode active material by weight.

The hydrogen storage alloy may be solid particles. To improving the function of the hydrogen storage alloy, its particles may be dispersed into the electrode material.

The electrode active material in the electrode material may include a cathode active material or an anode active material, as long as it includes the hydrogen storage alloy. The cathode active material may be any lithium metal oxide in the art. In some embodiments, the cathode active material may be chosen form lithium cobaltate, lithium nickelate, lithium manganate, lithium ferrous iron phosphate and a mixture thereof. In some embodiments, the cathode active material is lithium ferrous iron phosphate.

The anode active material may be any material in the art, for example, a carbon material. The carbon material may be chosen from non-graphitic carbon, graphite, pyrolytic carbon or carbon made from polyacetylenes polymers by high-temperature oxidation, coke, organic polymer sinter, mesocarbon microbeads (MCMB), petroleum coke, carbon fibers, polymeric carbon and a mixture thereof. In some embodiments, the anode active material has a lithium intercalation potential greater than about 0.6 V vs. Li⁺/Li, so that the hydrogen storage alloy functions better to relieve air-expansion. In some embodiments, the anode active material may be lithium titanate. It is thought that air-expansion in batteries, especially in batteries with lithium titanate as the anode active material, is caused by the production of a tremendous amount of hydrogen when too much water is introduced into the battery and reacts with the lithium element. The hydrogen storage alloy may effectively absorb hydrogen produced during battery formation or cycling. For batteries having lithium titanate as the anode active material and a lithium intercalation potential greater than about 0.6 V vs. Li⁺/Li, the absorbing effect may be more prominent. As a result, the present disclosure may relieve the severe air-expansion of batteries with lithium titanate as the anode active material, and provide safer and high quality batteries with outstanding cycling performance.

The adhesive can be any electrode adhesive used in the art. The adhesive can be chosen from polytetrafluoroethylene (PTFE), polyvinylidene fluoride (PVDF), hydroxymethyl cellulose (CMC), methylcellulose (MC) and styrene-butadiene rubber (SBR). The amount of the adhesive can range from about 0.01% to about 10% of the electrode active material by weight, preferably from about 0.02% to about 5% of the electrode active material by weight. In some embodiments, the electrode material can further comprise a conductive agent including without limitation at least one chosen from carbon nano-tubes, nano-silver powders, acetylene black, graphite powders and carbon black.

A lithium ion battery is disclosed herein comprising: a battery shell, an electrolyte and a battery core within the battery shell, wherein the battery core comprises a cathode, an anode and a separator therebetween, the cathode and/or the anode comprising a hydrogen storage alloy described above.

The electrolyte can include a gel electrolyte or a non-aqueous electrolyte. The gel electrolyte can include, for example, a polyvinylidene fluoride (PVDF) gel electrolyte. The non-aqueous electrolyte may comprise a lithium salt and a non-aqueous solvent. The lithium salt can be any lithium salt in the art including at least one chosen from lithium hexafluorophosphate, lithium tetrafluoroborate, lithium hexafluoroarsenate, lithium perchlorate, lithium trifluoromethylsulfonate, lithium perfluorobutane sulfonate, lithium aluminate, lithium chloroaluminate, fluorinated lithium sulfonimide, lithium chloride and lithium iodide. The non-aqueous solvent can be any non-aqueous solvent in the art including at least one chosen from gamma-butyrolactone, methyl ethyl carbonate, methyl propyl carbonate, dipropyl carbonate, anhydride, N-methyl pyrrolidone, N-dimethylformamide, N-methyl acetamide, acetonitrile, N,N-dimethylformamide, sulfolane, dimethyl sulfoxide, diethyl sulfite, and other unsaturated cyclic organic esters having fluorine and sulfur.

The following examples provide additional details of the embodiments of the present disclosure.

### EXAMPLE 1

(1) Preparation of Electrode Materials

Prepare a cathode slurry containing LiFePO₄, acetylene black, PVDF, and polyvinylpyrrolidone (PVP) with a weight ratio of about 100:5:6:0.5. Prepare an anode slurry containing lithium titanate (LiTi₅O₁₂), acetylene black, PVDF, polyvinylpyrrolidone (PVP) and NaNi₅ with a weight ratio of about 100:1:7:0.5:3.

(2) Preparation of the Electrodes

Prepare the electrodes with metal foil, usually the cathode being made of aluminum foil and the anode being made of copper foil. The thickness of the aluminum foil was about 12 microns; and the thickness of the copper foil was about 16 mm.

Coat the cathode or anode slurry on one side of the metal foil, and dry the metal foil at about 100° C. at the same time. Then coat the cathode or anode slurry on the other side of the metal foil, and dry the metal foil at about 100° C. at the same time. The slurry coating area of the cathode was 470×43 mm, and that of the anode was 490×44 mm. The capacity ratio of the cathode to the anode was about 1:1.1.

And then roll the metal foil with dried slurry on both sides to obtain the cathode or the anode. The thickness of one side of the cathode was about 118 microns, containing about 5.28 g of the electrode material, and having a volume density of about 2.2 g/cm³. The thickness of one side of the anode was about 91 microns, containing about 2.16 g of the electrode material, and having a volume density of about 0.86 g/cm³.

(3) Assembly of the Battery

Prepare a battery core by winding layers of electrodes and separators in an order of the cathode, the separator, the anode and the separator. Then fix a tab into a shell having a dimension of about 5 mm×50 mm×34 mm. Inject the electrolyte into the shell and seal the shell to form a lithium ion battery.

The lithium ion battery produced was labeled C1.

### EXAMPLE 2

The preparation method was substantially similar to that of Example 1 except for an anode slurry containing lithium titanate (LiTi₅O₁₂), acetylene black, PVDF, polyvinylpyrrolidone (PVP) and V—Ti with a weight ratio of about 100:1:7:0.5:3.

The lithium ion battery produced was labeled C2.

### EXAMPLE 3

The preparation method was substantially similar to that of Example 1 except for an anode slurry containing lithium titanate (LiTi₅O₁₂), acetylene black, PVDF, polyvinylpyrrolidone (PVP) and ZrCr₂ with a weight ratio of about 100:1:7:0.5:3.

The lithium ion battery produced was labeled C3.

### EXAMPLE 4

The preparation method was substantially similar to that of Example 1 except for an anode slurry containing lithium titanate (LiTi₅O₁₂), acetylene black, PVDF, polyvinylpyrrolidone (PVP) and ZrV₂ with a weight ratio of about 100:1:7:0.5:5.

The lithium ion battery produced was labeled C4.

### EXAMPLE 5

The preparation method was substantially similar to that of Example 1 except for an anode slurry containing lithium titanate (LiTi₅O₁₂), acetylene black, PVDF, polyvinylpyrrolidone (PVP) and ZrV₂ with a weight ratio of about 100:1:7:0.5:0.5.

The lithium ion battery produced was labeled C5.

### EXAMPLE 6

The preparation method was substantially similar to that of Example 1 except for an anode slurry containing lithium titanate (LiTi₅O₁₂), acetylene black, PVDF, polyvinylpyrrolidone (PVP) and ZrV₂ with a weight ratio of about 100:1:7:0.5:15.

The lithium ion battery produced was labeled C6.

### EXAMPLE 7

The preparation method was substantially similar to that of Example 1 except for an anode slurry containing graphite, acetylene black, PVDF, polyvinylpyrrolidone (PVP) and ZrCr₂ with a weight ratio of about 100:1:7:0.5:3.

The lithium ion battery produced was labeled C7.

### EXAMPLE 8

The preparation method was substantially similar to that of Example 1 except for a cathode slurry containing LiFePO₄, acetylene black, PVDF, polyvinylpyrrolidone (PVP) and ZrCr₂ with a weight ratio of about 100:5:6:0.5:3.

The lithium ion battery produced was labeled C8.

### REFERENCE 1

The preparation method was substantially similar to that of Example 1 except for an anode slurry containing lithium titanate (LiTi₅O₁₂), acetylene black, PVDF and polyvinylpyrrolidone (PVP) with a weight ratio of about 100:1:7:0.5.

The lithium ion battery produced was labeled D1.

### TESTING EXAMPLES

1. Capacity Testing

At room temperature, batteries C1-C8 and D1 were charged at a first current of 0.05 C for 4 hours, and then charged at a second current of 0.1 C for 6 hours until the battery voltage was 2.5 V. Then batteries were charged at a constant voltage of 2.5V until the battery cut-off current was 10 mA. After that the batteries was discharged at 1 C until the voltage was 1.3 V. The thickness T1 of the batteries at the ending of 4-hour 0.05 C charging and the initial discharge capacity of the batteries were recorded as shown in Table 1.

2. Cycling Performance Testing

At room temperature, batteries C1-C8 and D1 were charged at a current of 1 C, and then discharged at 1 C. Such cycle was repeated for 1000 times. The initial discharge capacity of the batteries at the first cycle and the discharge capacity at the 1000th cycle were recorded, and the capacity retention rate was calculated with the following formula:

Capacity retention rate=(the discharge capacity at the 1000th cycle/the initial discharge capacity at the first cycle)×100%.

Meanwhile, the thickness T2 of the batteries at the end of the 1000th cycle was also recorded.

The results are shown in Table 1.

TABLE 1

| | T1/ | Initial Discharge Capacity/ | | capacity retention |
|---|---|---|---|---|
| Battery | mm | mAh | T2/mm | rate/% |
| C1 | 5.32 | 652 | 5.45 | 93.8 |
| C2 | 5.29 | 654 | 5.52 | 94.1 |
| C3 | 5.23 | 652 | 5.36 | 96.2 |
| C4 | 5.24 | 653 | 5.38 | 95.9 |
| C5 | 5.48 | 657 | 5.62 | 94.2 |
| C6 | 5.31 | 652 | 5.36 | 93.1 |
| C7 | 5.49 | 656 | 5.72 | 91.7 |
| C8 | 6.08 | 654 | 7.16 | 90.4 |
| D1 | 6.29 | 658 | 8.28 | 90.8 |

According to the above tests, the present disclosure can relieve air-expansion of lithium ion batteries during formation and cycling, especially for batteries using lithium titanate as its electrode active material. As a result, safer and high quality batteries with outstanding cycling performance may be formed according to the present disclosure.

Although the disclosure has been described in detail with reference to several embodiments, additional variations and modifications exist within the scope and spirit of the disclosure as described and defined in the following claims.

What is claimed is:

1. An electrode material for a lithium ion battery, comprising an electrode active material, an adhesive and a hydrogen storage alloy.

2. The electrode material according to claim 1, wherein the hydrogen storage alloy includes at least one selected from AB₅ type Nickel based hydrogen storage alloys, AB₂ type Laves phase hydrogen storage alloys, A₂B type Magnesium based hydrogen storage alloys, and V-based solid solution type hydrogen storage alloys.

3. The electrode material according to claim 2, wherein the hydrogen storage alloy includes AB2 type Laves phase hydrogen storage alloys.

4. The electrode material according to claim 3, wherein the AB₂ type Laves phase hydrogen storage alloys include at least one selected from ZrV₂, ZrCr₂ and ZrMn₂.

5. The electrode material according to claim 1, wherein the hydrogen storage alloy ranges from about 0.1% to about 20% of the electrode active material by weight.

6. The electrode material according to claim 5, wherein the hydrogen storage alloy ranges from about 0.5% to about 5% of the electrode active material by weight.

7. The electrode material according to claim 1, wherein the electrode active material includes a cathode active material.

8. The electrode material according to claim 7, wherein the cathode active material comprises a lithium metal oxide.

9. The electrode material according to claim 1, wherein the electrode active material includes an anode active material.

10. The electrode material according to claim 9, wherein the anode active material has a lithium intercalation potential greater than about 0.6 V vs. Li+/Li.

11. The electrode material according to claim 10, wherein the anode active material is lithium titanate.

12. A lithium ion battery, comprising:
a battery shell, an electrolyte and a battery core within the battery shell, wherein the battery core comprises a cathode, an anode and a separator therebetween, the cathode and/or the anode comprising a hydrogen storage alloy.

13. The lithium ion battery according to claim 12, wherein the hydrogen storage alloy includes at least one selected from AB₅ type Nickel based hydrogen storage alloys, AB₂ type Laves phase hydrogen storage alloys, A₂B type Magnesium based hydrogen storage alloys, and V-based solid solution type hydrogen storage alloys.

14. The lithium ion battery according to claim 13, wherein the hydrogen storage alloy includes AB₂ type Laves phase hydrogen storage alloys.

15. The lithium ion battery according to claim 14, wherein the AB₂ type Laves phase hydrogen storage alloys include at least one selected from ZrV₂, ZrCr₂ and ZrMn₂.

16. The electrode material according to claim 1, wherein the hydrogen storage alloy comprises solid particles dispersed in the electrode material.

17. The electrode material according to claim 1, wherein the electrode material further comprises a conductive agent.

18. The electrode material according to claim 1, wherein the adhesive ranges from about 0.01% to about 10% of the electrode active material by weight

19. The electrode material according to claim 1, wherein the adhesive ranges from about 0.02% to about 5% of the electrode active material by weight.
